(19) United States
(12) Patent Application Publication
(10) Pub. No.: US 2019/0087545 A1
(43) Pub. Date: Mar. 21, 2019

(54) SYSTEM FOR TRACKING THE DISPENSING OF MEDICATIONS

(71) Applicant: Curtis Sizer, Denver, CO (US)

(72) Inventor: Curtis Sizer, Denver, CO (US)

(21) Appl. No.: 15/709,455

(22) Filed: Sep. 19, 2017

(51) Int. Cl. G06F 19/00; G06Q 10/08; A61J 7/00; G06Q 50/22; A61J 7/04

(52) U.S. Cl. CPC G06F 19/3462; G06Q 10/0875; G07F 17/0092; G06Q 50/22; A61J 7/04; A61J 7/0076

(57) ABSTRACT

The present system for tracking the dispensing of medications using an apparatus for monitoring the location and use of Medication Containers in the dispensing of medications contained therein, makes use of one or more Location Determining Devices, each affixed to a corresponding Medication Container, for determining a present location of the Medication Container to which it is affixed and a Control Module, in wireless communication with the Location Determining Devices, for identifying both the determined present location of the Medication Container to which it is affixed as well as operation of the Medication Container.

### FIELD OF THE INVENTION

This system for tracking the dispensing of medications relates to the controllable dispensing of prescription and over-the-counter medications to patients. The system also provides the capability to detect unscheduled and improper access to the medications as well as the real-time location of the containers in which the medications are stored.

### BACKGROUND OF THE INVENTION

In the field of medication dispensing, there are several types of systems, each of which addresses one particular attribute of the problem of controllable dispensing prescribed doses of medications. In particular, the field can be divided into pill reminders, pill dispensers, and combinations thereof.

The pill reminder systems represent a timed function - apparatus that automatically generates an audible/visual indication to the patient after the expiry of a predetermined time period to thereby alert the patient that it is time to take the associated medication.

The pill dispenser systems are activated either on command or on a timed basis to provide access to the medications contained therein after the expiry of a predetermined time period. These pill dispenser systems can optionally contain sensors that determine the quantity of doses contained therein via weight measurements to ensure that only the proper dose is withdrawn therefrom. These systems also typically include wireless communication capability to forward information and alerts to a remotely located monitoring system. These systems may or may not include an individual dose dispensing capability to prevent access to a reservoir of medication doses, and only dispense a unit dose at each timed interval or may enable access to an inventory of medication doses. These systems also include multi bottle pill dispenser systems which serve to deliver a multitude of medications to a patient.

There are also systems that both automatically generate an audible/visual indication to the patient after the expiry of a predetermined time period to thereby alert the patient that it is time to take the associated medication and also provide access to the medications contained therein after the expiry of a predetermined time period.

### BRIEF SUMMARY OF THE INVENTION

It is estimated that the healthcare industry is burdened by 4-5 billion dollars per year from users/patients improperly consuming their prescription medications and over the counter products. The present system for tracking the dispensing of medications aids and/or eliminates user overdosing and/or missed dosage by making use of a Location Determining Device, affixed to a corresponding Medication Container, for determining a present location of the Medication Container to which it is affixed and a Control Module, in wireless communication with the Location Determining Device, for identifying both the determined present location of the Medication Container to which it is affixed and also operation of the Medication Container.

Control Module also helps to positively impact healthcare industries and doctor/patient liability associated with medications and over the counter products. If a vital system for monitoring and double checking the condition of home health care and nursing home individuals taking medication and also ensures that controlled medication such as narcotics and other substances is monitored and better controlled.

### BRIEF DESCRIPTION OF THE DRAWINGS

FIG. 1 illustrates, in block diagram form, one embodiment of a Medication Container equipped with the Location Determining Device and Container Opening Sensor of the present system for tracking the dispensing of medications;

FIG. 2 illustrates, in block diagram form, one embodiment of the present system for tracking the dispensing of medications;

FIG. 3 illustrates in flow diagram form, the operation of the present system for tracking the dispensing of medications;

FIG. 4 illustrates a typical Personal Pill Reminder; and

FIG. 5 illustrates a typical Personal Monitoring Device.

### DETAILED DESCRIPTION OF THE INVENTION

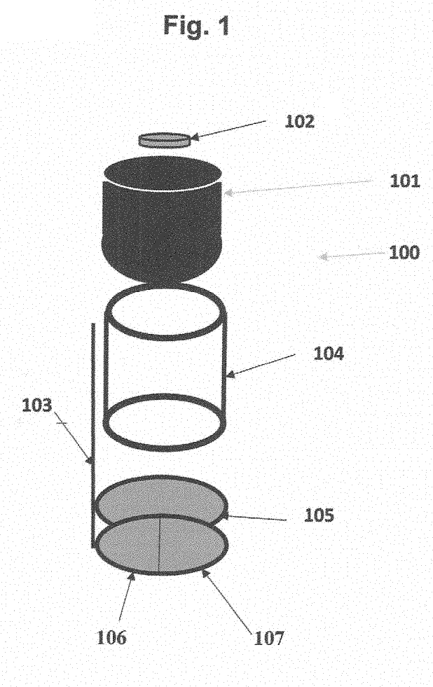

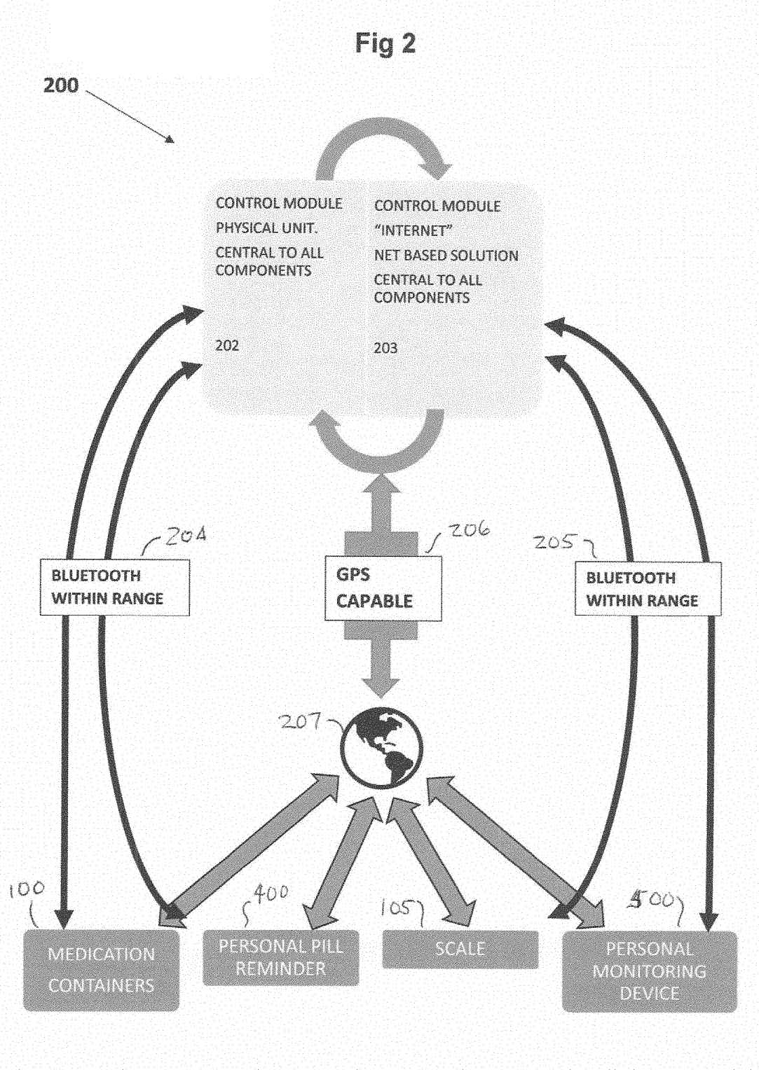

FIG. 1 illustrates, in block diagram form, one embodiment of a Medication Container 100 that is equipped with the Location Determining Device 106 and Container Opening Sensor 103 and FIG. 2 illustrates, in block diagram form, one embodiment of the present system for tracking the dispensing of medications 201. The present system for tracking the dispensing of medications 201 aids and/or eliminates user overdosing and/or missed dosage by making use of a Location Determining Device 106 for determining a present location of the Medication Container 100 to which it is affixed and a Control Module 200, in wireless communication with the Location Determining Device 106, for identifying both the determined present location of the Medication Container 100 to which it is affixed and also operation of the Medication Container 100. The Medication Container 100 is loaded with medications intended for the upcoming week or a pre-determined time period, then the Control Module 200 is “reset” to initiate the medication dispensing sequence for the upcoming pre-determined time period.

### Medication Container 100

The Medication Container 100 can come in various forms. Medication Container 100 can be an individual bottle or a Personal Pill Reminder 400 that has an intended use of temporary storage and division of medication to be consumed during an upcoming time period. A locking compartment may be added as an additional enhancement. Personal Pill Reminder 400 refers to a container that holds and organizes medication/items that are to be loaded and kept for use at a later date.

The basic components of the Medication Container 100 are a Medication Repository 104 (such as a jar or bottle or multi-segment tray) which is filled with predetermined medications and enclosed by a Cap 101. The Medication Container 100 is processor-based and includes a Platform 105 on which the Medication Repository 104 is placed. The Platform 105 contains a Location Determining Device 106, described below, which computes a present location of the Medication Container 100 and its associated Medication Repository 104, which data is wirelessly transmitted by the processor function of the Medication Container 100 to an associated Control Module 200 via a Transceiver 107, as described below.

The Medication Container 100 and Personal Pill Reminder 400 include multiple sensors (not shown) located on the preloaded Medication Container 100, with various configurations of days and time controlled and programmed by the Control Module 200. The Medication Container 100 and Personal Pill Reminder 400 can optionally include audible, time activated alarms. In addition, there are many types of sensors available to be included in the Medication Container 100 and Personal Pill Reminder 400, which are customizable as needed. Some examples of sensors are: location, weight, time, and open/closed. A Container Opening Sensor 103 can be comprised of a Magnet 102 and a Magnetic Sensitive Switch 103 or, optionally, an orientation indicator (not shown) which uses a 3-axes magnetometer in the Platform 105 of the Medication Container 100. A magnetometer can gather information of vessel movement to a 1 m radius. Container Opening Sensor 103 monitors an individual Medication Repository 104.

### Location Determining Device 106

The Location Determining Device 106 is an integral part of the Medication Container 100 and functions in a well-known manner to receive location identification signals extant in the space around the Medication Container 100 and compute data using these reference signals to precisely identify the present location of the Medication Container 100. Examples of such location identification systems and their signals are noted herein.

### Geolocation

Geolocation is the identification or estimation of the real-world geographic location of an object where the locating engine often uses radio frequency (RF) location methods. Indoor positioning systems are optimized for use within individual rooms, buildings, or construction sites and are typically based on a principle of trilateration, which relies on multiple ultrasonic receivers embedded in the ceiling and measures time-of-flight to them. An indoor positioning system (IPS) is a system to locate objects or people inside a building using radio waves, magnetic fields, acoustic signals, or other sensory information collected by mobile devices. A Wi-Fi positioning system (WPS) can be used where GPS is inadequate. The localization technique used for positioning with wireless access points is based on measuring the intensity of the received signal and “fingerprinting” the object to authenticate its identity.

### Global Positioning System (GPS)

The GPS concept is based on time and the known position of specialized satellites. The satellites carry very stable atomic clocks that are synchronized with one another and to ground clocks. Any drift from true time maintained on the ground is corrected daily. Likewise, the satellite locations are known with great precision. GPS receivers have clocks as well; however, they are usually not synchronized with true time, and are less stable. GPS satellites continuously transmit their current time and position. A GPS receiver monitors multiple satellites and solves equations to determine the precise position of the receiver and its deviation from true time. At a minimum, four satellites must be in view of the receiver for it to compute four unknown quantities (three position coordinates and clock deviation from satellite time).

Other satellite navigation systems in use or various states of development include:
GLONASS—Russia's global navigation system. Fully operational worldwide;
Galileo—a global system being developed by the European Union and other partner countries;
Beidou—People's Republic of China's regional system, currently limited to Asia and the West Pacific, global coverage planned to be operational by 2020.

### Container Opening Sensor 103

The Container Opening Sensor 103 can be comprised of a Magnet 102 and associated Magnetic Sensitive Switch (part of 103) or, optionally, an Orientation Indicator (not shown) which uses a 3-axes magnetometer in the Platform 105 of the Medication Container 100. A magnetometer can gather information of vessel movement to a lm radius. Container Opening Sensor 103 monitors an individual Medication Repository 104. The Container Opening Sensor 103 communications with the Platform 105 any change in the status of the Container Opening Sensor 103. The Container Opening Sensor 103 consists of two parts: a disposable Magnet 102 that adheres to the top or Lid 101 of the Medication Repository 104 and a Platform 105. When the Lid 101 (with the Magnet 102) and the of the Medication Repository 104 are separated, the Container Opening Sensor 103 notifies the Control Module 200 that the Medication Repository 104 was opened or tampered with through GPS. The Medication Container 100 communicates with the Control Module 200 wirelessly. The Medication Container 100 can be outfitted with three sensors. Two are used for per opening “door” to reduce the chance of a false reading. The third sensor is a feature of weight measurement for each pill in the individual dividers. This is to ensure the correct amount of medication has been divided for each dosage. The Medication Container 100 is outfitted with a function that “resets” the unit when the Medication Repository 104 has been refilled, it is then ready for a new cycle. The key feature of this device is it has GPS capabilities. The Medication Container 100 communicates directly to the Control Module 200 via a transceiver 107. The Medication Container 100 immediately identifies any changes to its condition or whereabouts to the Control Module 200.

Another key feature to the Container Opening Sensor 103, is that the user and/or caretaker never contaminates medications by moving or touching non FDA approved materials/containers, alter the labels of medication causing confusion, or lose track of medication by accidental spillage when moving to different containers or “pill boxes”. A pharmacy could incorporate the Container Opening Sensor 103 into a standard Container or vessel to allow a physician or emergency responder to know what medications the individual is taking. When refilling the Container the consumer could simply swap out the container. A pharmacy could use the system to control medications easier with an individual GPS location and open/close condition indicator.

### Control Module 200

Control Module 200 refers to any programmable electronic medium that communicates with all the parts of this system. Some examples may include a computer, laptop, tablet, smart phone or custom electronic device. The Control Module 200 is capable of storing, forwarding and/or receiving data from devices in the system. The Control Module 200 broadcasts and receives signals from devices in the system. The broadcast signals may include, but are not limited to radio signals. The Control Module 200 includes a in the application as an in-home/facility unit that can easily be programed with its LCD touch screen, to keep track or centralize the medication “maintenance”. This is typically a mobile App and/or computer program/webpage. The Location Determining Device 106 and Container Opening Sensor 103 attach to an existing prescription bottle(s) and/or other containers. It then communicates with the Control Module 200. It's also important to note that the Control Module 200 is not limited to monitoring just one Medication Container 104 and its associated Location Determining Device 106 and Container Opening Sensor 103. Multiple Medication Containers 100 can be tracked with the Control Module 200.

Control Module 200 can be connected to the Internet 206 which in turn can work with mobile functionality for the purpose of texting or communication with user app. to keep track and report activities concerning the Container attachments. The Control Module 200 is where the consumer and/or caretaker programs in such things as dosage, amounts, frequency, etc. After programing, the Control Module 200 is the controller of the entire system. As the Control Module 200 knows the location and condition of each medication vessel, it can easily monitor the misuse of any controlled substance.

### System Operation

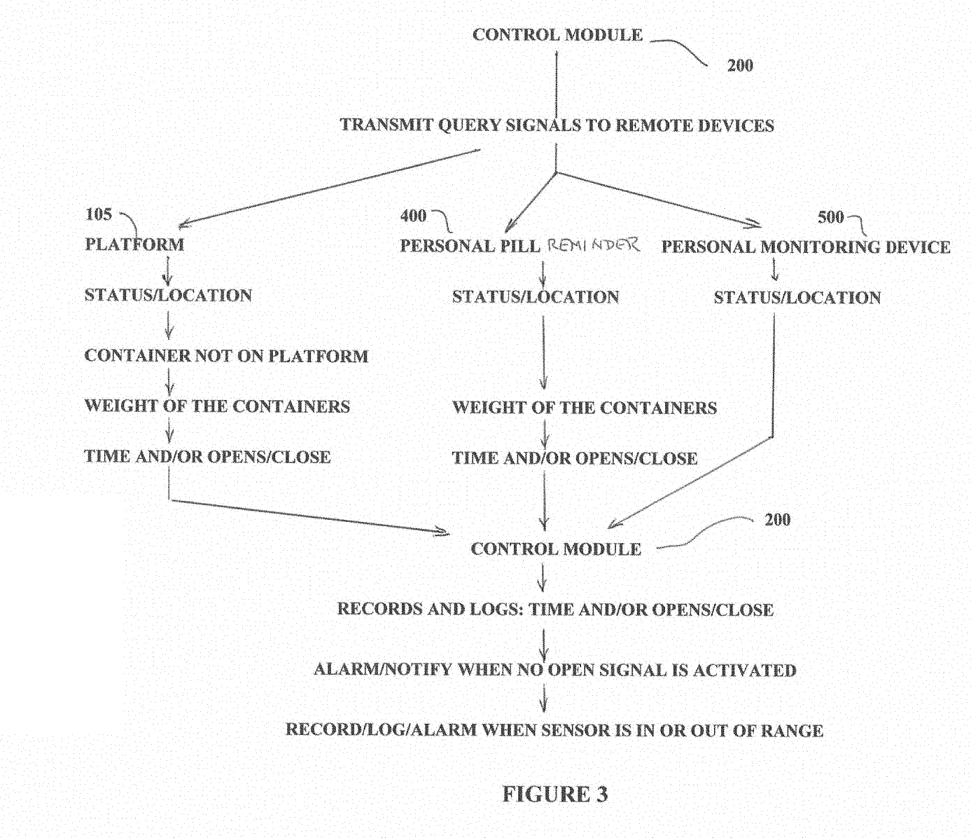

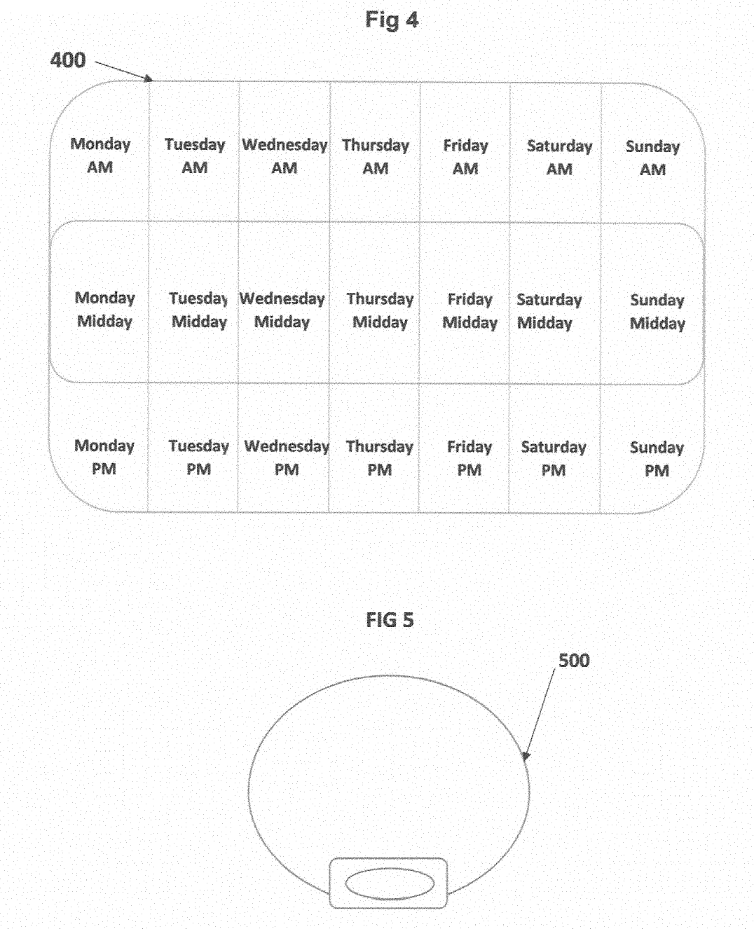

FIG. 3 illustrates in flow diagram form, the operation of the present system for tracking the dispensing of medications 201. Both the Personal Monitoring Device 500 and Container Opening Sensor 103 are designed to alert the consumer and/or caretaker of time of dosage, type of dosage, etc. It does so by sounding an alarm (optional) along with displaying a flashing light. While in this “reminder mode” the Control Module 200 displays what medication(s) is due to be taken through a mobile Application or computer Control Module 200 interface.

An important key feature of the Control Module 200 is that it has the ability to communicate with wireless internet and/or mobile technology 203. Alerts can then be sent to the user and/or a caretaker (example 1—the user can get an alert on their smartphone that it's time for a medication; example 2—an elderly individual forgets to take their medication or misuses their medication, an alert can be sent to a family member, healthcare professional, caregiver, etc.).

As shown in FIG. 3, the Control Module 200 transmits queries to the various elements in the system to determine their status typically via a Bluetooth connection 204, 205. In particular, Control Module 200 transmits a query via Transceiver 107 to the Platform 105 via the processor in the Medication Container 100 to determine the state of the various sensors associated with that Platform 105. These data include status/location of the Platform 105; whether or not the Medication Repository 105 is in position on the Platform 105; weight of the Medication Repository 104; and time of Medication Repository 104 open and close events. These data accumulated by the Platform 105 are returned to the Control Module 200 via Transceiver 107. Control Module 200 in response to receipt of this information records and logs the time of Medication Repository 104 open and close events as well as the determined location of the Medication Container 100. The Control Module 200 will generate an alarm/notification when no record of the opening of the Medication Repository 104 is received according to the predetermined medication dispensing schedule or that too many events have occurred. Similarly, an alarm/notification is generated if the Medication Container 100 is out of range or in a location that is not within the allotted spatial range for this device. These alarms are typically transmitted to the patient's caregiver and/or responsible family members.

This series of operations are also followed in the case of the Personal Pill Reminder 400 as shown on FIG. 3. In addition, the Personal Monitoring Device 500 is queried to determine the present location of this device. Furthermore, the Personal Monitoring Device 500 can initiate a communication to the Control Module 200 is activated by the wearer or if it senses an anomaly in the physical characteristics of the wearer.

### Personal Monitoring Device

The Personal Monitoring Device 500 refers to a wearable personal device capable of immediately relaying medication information to an authorized source. The Control Module 200 is designed to report all activity associated with the Personal Monitoring Device 500 and Container Opening Sensor 103. If it senses that a Medication Container 100 has been opened at the wrong time or too soon (example—the user takes their medication but then an hour later forgets and attempts to take the same medication again) the Control Module 200 initiates an audible alarm to the Personal Monitoring Device 500 or Container Opening Sensor 103.

### Control Module Tasks

The Control Module 200 can accomplish a myriad of tasks, which can include, but is not limited to:
1) Continually monitors the status/location of the Medication Container 100.
2) Continually monitors the status/location of the Personal Pill Reminder 400
3) Continually monitors the status/location of the platform: tracking the weight of the Personal Pill Reminder 400 or individual Medication Containers 100.
4) Responds to the Personal Monitoring Device 500, which is a programmable wristband or other “on person” device that can provide critical information immediately.
5) Records and Logs: Time and/or Opens/Close of Medication Container 100
6) Alarms—visual display, audible alarm; any means to obtain the attention of end user or care giver weather through electronic signal or radio communications.
7) Send out signals to remote devices when prompted
8) Alarm/notify when no Medication Container 100 open signal is activated
9) Record/log/alarm when sensor is in or out of range of a specific location

### Programing The Control Module 200

The Control Module 200 is programmable for a plurality of actions. Including but not limited to:

a. Medication Repository 104 needs to be opened

b. Medication Repository 104 not opened on time

c. Medication Repository 104 is out of range and/or not on platform

d. Prescriber information

e. Personal Monitoring Device information

Example of programing the Control Module 200 (also with its touch screen):
“Add Medication/Product” (medication/product name, description, etc. is up to user(s) if concerned about HiPPA, privacy, etc.)
“Particular Container Opening Sensor 103 to be Used” (1, 2, 3, 4 . . . )
“User Name” (unlimited number of users can be programed into the Control Module 200 including family pets)
“Times Per Day”
“Time of Day” (offering morning and night suggestions, however this can be altered)
“Duration” (for temporary medications such as antibiotics, etc.)

The Control Module 200 next asks if there is a party that it should notify if the mobile alerts and communication feature is desired. This feature is optional. It works by entering a phone number for a text message, or by notifying through an “app” loaded on a smartphone. The Control Module 200 then asks for a length of time before notification (such as 15 minutes, 30 minutes, 1 hour, 2 hours, etc.). When this time is entered, the system knows what Container Opening Sensor 103 is attached and what time of day the medication must be taken.

### SUMMARY

The present system for tracking the dispensing of medications using an apparatus for monitoring the location and use of Medication Containers in the dispensing, of medications contained therein, makes use of one or more Location Determining Devices, each affixed to a corresponding Medication Container, for determining a present location of the Medication Container to which it is affixed and a Control Module, in wireless communication with the Location Determining Devices, for identifying both the determined present location of the Medication Container to which it is affixed as well as operation of the Medication Container.

1. Apparatus for monitoring the location and use of Medication Containers in the dispensing of medications contained therein wherein the Medication Container comprises a container and an associated closure, for containing at least one dose of a medication and operable to deliver a dose of the medication contained therein, comprising:
a Container Opening Sensor for generating an access signal if the closure is operated, indicating that a medication was taken by a user;
a Location Determining Device, affixed to a Medication Container, for generating geolocation signals indicative of a present location of the Medication Container to which it is affixed;
a Control Module located remotely from the Medication Container and in wireless communication with the Medication Container;
a Processor, located in the Medication Container and in communication with the Location Determining Device and the Container Opening Sensor for wirelessly transmitting the geolocation signals and the access signal to the Control Module; and
wherein the Control Module is responsive to the received geolocation signals and access signals, for identifying the present location of the Medication Container to which it is affixed and an indication that a medication was taken by a user.

2. The apparatus for monitoring the location and use of Medication Containers of claim 1 wherein the Location Determining Device comprises:
a radio frequency-based Geolocation Receiver, which is responsive to receipt of a plurality of externally generated radio frequency beacon signals for generating geolocation signals indicative of a present physical location of the Medication Container.

3. The apparatus for monitoring the location and use of Medication Containers of claim 1 wherein the Location Determining Device comprises:
a GPS Receiver, which is responsive to receipt of a plurality of externally generated GPS signals for generating geolocation signals indicative of a present physical location of the Medication Container.

4. The apparatus for monitoring the location and use of Medication Containers of claim 1 wherein the Location Determining Device comprises:
an Indoor Positioning System which uses received trilateration signals for generating geolocation signals indicative of a present physical location of the Medication Container.

5. (canceled)

6. (canceled)

7. (canceled)

8. The apparatus for monitoring the location and use of Medication Containers of claim 1 wherein:
the Processor is responsive to a location query signal received from the Control Module for activating the Location Determining Device to generate geolocation signals indicative of a present location of the Medication Container to which it is affixed; and
the Processor wirelessly transmits the generated geolocation signals to the Control Module.

9. The apparatus for monitoring the location and use of Medication Containers of claim 1 wherein:
the Processor is responsive to a container status query signal received from the Control Module for activating the Container Opening Sensor to generate access signals indicative of operation of the closure, indicating that a medication was taken by a user; and
the Processor wirelessly transmits the generated access signals to the Control Module.

10. The apparatus for monitoring the location and use of Medication Containers of claim 1 further comprising:
a Memory, in communication with the Processor, for recording a history of instances where the closure is removed from the container, indicating that a medication was taken by a user.

11. The apparatus for monitoring the location and use of Medication Containers of claim 1 further comprising:
a Clock for recording in the Memory the time of each instance where the closure is removed from the container, indicating that a medication was taken by a user.

12. Apparatus for monitoring the location and use of Medication Containers, wherein the Medication Container comprises a container and an associated closure for containing at least one dose of a medication and operable to deliver a dose of the medication contained therein, comprising:
a Container Opening Sensor for generating an access signal if the closure is operated, indicating that a medication was taken by a user;
a Location Determining Device, affixed to a Medication Container, responsive to the access signal, for generating geolocation signals indicative of a present location of the Medication Container to which it is affixed; and
a Control Module located remotely from the location determining device and in wireless communication with the Location Determining Device and Container Opening Sensor and responsive to geolocation signals and access signal received therefrom, for identifying the present location of the Medication Container to which it is affixed.

13. (canceled)

14. The apparatus for monitoring the location and use of Medication Containers of claim 12 wherein the Location Determining Device comprises:
a radio frequency-based Geolocation Receiver, which is responsive to receipt of a plurality of externally generated radio frequency beacon signals for generating geolocation signals indicative of a present physical location of the Medication Container.

15. The apparatus for monitoring the location and use of Medication Containers of claim 12 wherein the Location Determining Device comprises:
a GPS Receiver, which is responsive to receipt of a plurality of externally generated GPS signals for generating geolocation signals indicative of a present physical location of the Medication Container.

16. The apparatus for monitoring the location and use of Medication Containers of claim 12 wherein the Location Determining Device comprises:
an Indoor Positioning System which uses received trilateration signals for generating geolocation signals indicative of a present physical location of the Medication Container.

17. (canceled)

18. The apparatus for monitoring the location and use of Medication Containers of claim 12 further comprising:
a Processor in communication with the Location Determining Device and the container opening sensor for wirelessly transmitting the geolocation signals and the access signal to the Control Module.

19. The apparatus for monitoring the location and use of Medication Containers of claim 12 wherein:
the Processor is responsive to a location query signal received from the Control Module for activating the Location Determining Device to generate geolocation signals indicative of a present location of the Medication Container to which it is affixed; and
the Processor wirelessly transmits the generated geolocation signals to the Control Module.

20. The apparatus for monitoring the location and use of Medication Containers of claim 12 wherein:
the Processor is responsive to a container status query signal received from the Control Module for activating the Container Opening Sensor to generate access signals indicative of operation of the closure, indicating that a medication was taken by a user; and
the Processor wirelessly transmits the generated access signals to the Control Module.

21. The apparatus for monitoring the location and use of Medication Containers of claim 12 further comprising:
a Memory, in communication with the Processor, for recording a history of instances where the closure is removed from the container, indicating that a medication was taken by a user; and
a Clock for recording in the Memory the time of each instance where the closure is removed from the container, indicating that a medication was taken by a user.
